(19) United States
(12) Patent Application Publication
(10) Pub. No.: US 2026/0328300 A1
(43) Pub. Date: Oct. 22, 2026

(54) Pressure Specific Air Chuck Device

(71) Applicant: Victor Garcia, Mora, NM (US)

(72) Inventor: Victor Garcia, Mora, NM (US)

(21) Appl. No.: 19/180,441

(22) Filed: Apr. 16, 2025

(51) Int. Cl. F16K 15/06

(52) U.S. Cl. CPC F16K 15/063

(57) ABSTRACT

A pressure specific air chuck device for triggering release of an air chuck from a valve stem when a specific air pressure has been achieved includes a housing having an open first end and an open second end. Each of a pair of jaws is positioned adjacent to the second end of the housing for engaging a valve stem inserted into the second end. A rod is positioned within the housing and mechanically coupled to the jaws such that movement of the rod pivots the jaws between a closed position and an open position. A pressure spring is positioned in the housing biasing the rod to hold the pair of jaws in the closed position. The pressure spring has a pressure spring constant corresponding to a specific air pressure to compress at the specific pressure within the housing pivoting the pair of jaws into the open position.

### (b) CROSS-REFERENCE TO RELATED APPLICATIONS

Not Applicable.

### (c) STATEMENT REGARDING FEDERALLY SPONSORED RESEARCH OR DEVELOPMENT

Not Applicable.

### (d) THE NAMES OF THE PARTIES TO A JOINT RESEARCH AGREEMENT

Not Applicable.

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable.

### (g) BACKGROUND OF THE INVENTION

### (1) Field of the Invention

The disclosure relates to air chuck devices and more particularly pertains to a new air chuck device for triggering release of an air chuck from a valve stem when a specific air pressure has been achieved.

### (2) Description of Related Art Including Information Disclosed Under 37 CFR 1.97 and 1.98

The prior art relates to air chuck devices.

### (h) BRIEF SUMMARY OF THE INVENTION

An embodiment of the disclosure meets the needs presented above by generally comprising a housing having an open first end and an open second end. Each of a pair of jaws is positioned adjacent to the second end of the housing for engaging a valve stem inserted into the second end. A rod is positioned within the housing and mechanically coupled to the jaws such that movement of the rod pivots the jaws between a closed position and an open position. A pressure spring is positioned in the housing biasing the rod to hold the pair of jaws in the closed position. The pressure spring has a pressure spring constant corresponding to a specific air pressure to compress at the specific pressure within the housing pivoting the pair of jaws into the open position.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a side view of a pressure specific air chuck device according to an embodiment of the disclosure.

FIG. 2 is a front view of an embodiment of the disclosure.

FIG. 3 is a cross-sectional view of an embodiment of the disclosure taken along line 3 -3 of FIG. 2.

FIG. 4 is a cross-sectional view of an embodiment of the disclosure taken along line 4 -4 of FIG. 2.

FIG. 5 is a cross-sectional view of an embodiment of the disclosure taken along line 5 -5 of FIG. 2.

FIG. 6 is a cross-sectional view of an embodiment of the disclosure taken along line 6-6.

FIG. 7 is a partial cut away side view of an embodiment of the disclosure in use.

### (j) DETAILED DESCRIPTION OF THE INVENTION

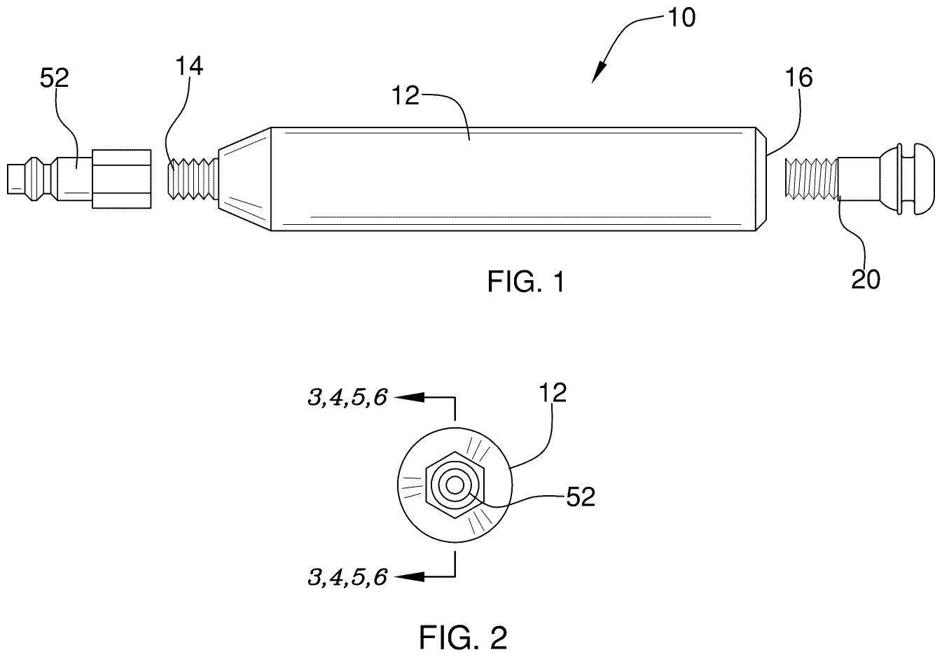

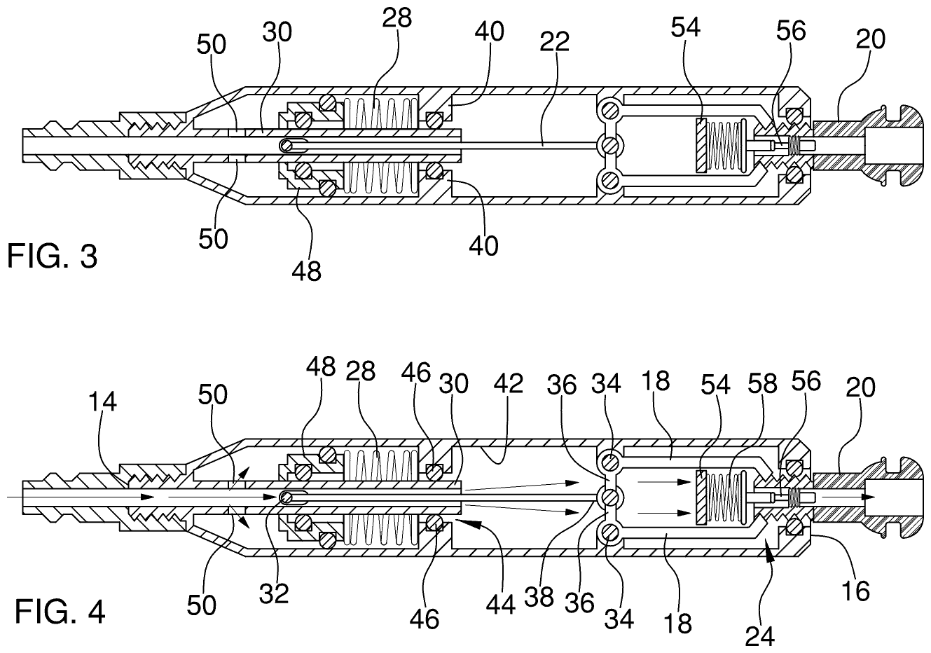

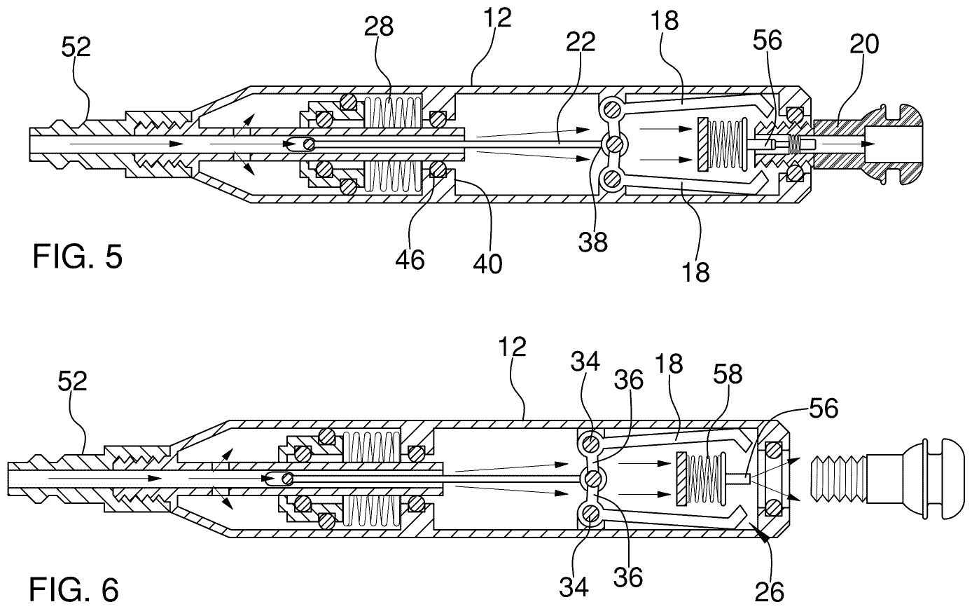

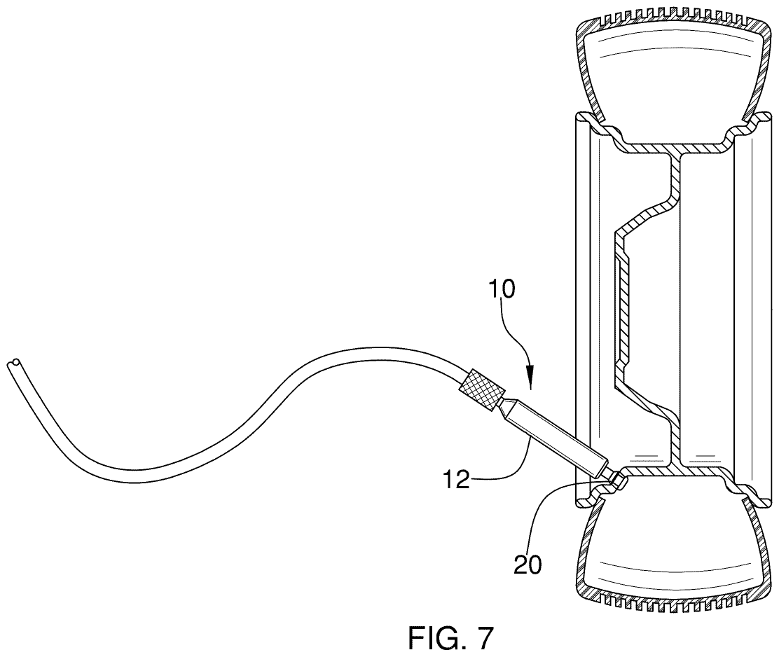

With reference now to the drawings, and in particular to FIGS. 1 through 7 thereof, a new air chuck device embodying the principles and concepts of an embodiment of the disclosure and generally designated by the reference numeral 10 will be described.

As best illustrated in FIGS. 1 through 7, the pressure specific air chuck device 10 generally comprises a housing 12 having a first end 14 and a second end 16. The first end 14 is open and the second end 16 is open. Each of a pair of jaws 18 is positioned within the housing 12. The jaws 18 are positioned adjacent to the second end 16 of the housing 12. The jaws 18 are configured for engaging a valve stem 20 inserted into the second end 16. A rod 22 is positioned within the housing 12. The rod 22 is mechanically coupled to the pair of jaws 18 such that linear movement of the rod 22 within the housing 12 pivots the pair of jaws 18 between a closed position 24 and an open position 26. A pressure spring 28 is positioned in the housing 12. The pressure spring 28 biases the rod 22 to hold the pair of jaws 18 in the closed position 24. The pressure spring 28 has a pressure spring constant corresponding to a specific air pressure within the housing 12 such that the pressure spring 28 compresses at the specific pressure within the housing 12. Thus, as pressure through the valve stem 20 equalizes within the housing 12 and reaches the specific pressure, i.e. the desired pressure to be achieved by inflation through the valve stem 20, the rod 22 pivots the pair of jaws 18 into the open position 26 facilitating release of the valve stem 20 from connection to the housing 12 through the second end 16.

A channel 30 extends into the housing 12 from the first end 14. The rod 22 has a primary end 32 positioned within the channel 30. The channel 30 has a diameter greater than a diameter of the rod 22 wherein the channel 30 is configured for air to pass through the channel 30 around the rod 22.

Each of the pair of jaws 18 has a pivot end 34 pivotally coupled to the housing 12. Each of the pair of jaws 18 further has a flange 36 extending from the pivot end 34 inwardly within the housing 12. A secondary end 38 of the rod 22 is pivotally coupled to the flange 34 of each jaw 18 of the pair of jaws 18. Thus, movement of the rod 22 pivots the pair of jaws 18.

A ridge 40 is positioned within the housing 12. The ridge 40 extending inwardly from an interior surface 42 of the housing 12 defining an aperture 44 within the housing 12. The channel 30 extends through the aperture 44. A channel seal 46 is positioned between the ridge 40 and the channel 30. A piston 48 is positioned within the housing 12. The piston 48 is positioned around the channel 30. The pressure spring 28 is positioned between the piston 48 and the ridge 40. A hole 50 is positioned in the channel 30. This may be a single hole or one of a plurality of holes 50. The hole 50 is positioned between the piston 48 and the first end 14 of the housing 12 wherein an air pressure within the housing 12 is equalized on opposite sides of the ridge 40. A quick connect inlet 52 may be coupled to the first end 14 of the housing 12 to facilitate connection of the housing 12 to a source of compressed or pressurized air.

A cross member 54 is positioned within and extends across the housing 12. The cross member 54 allows air within the housing 12 to pass around the cross member 54. The cross member 54 is positioned proximate the second end 16 of the housing 12. A pin 56 is slidably positioned within the housing 12 adjacent to the second end 16 wherein the pin 59 is configured for engaging the valve stem 20 in a conventional manner to allow air flow through the valve stem 20 when the valve stem 20 is inserted into the second end 16 of the housing 12. A closure spring 58 is positioned between the cross member 54 and the pin 56 wherein the closure spring 58 biases the pin 56 towards the second end 16 of the housing 12.

In use, the housing 12 is attached to the source of compressed or pressurized air using the quick connect inlet 52. The housing 12 is manipulated to insert the valve stem 20 into the second end 16 of the housing 12. The jaws 18 pivot by the insertion of the valve stem 20 and are biased to the closed position to facilitate retention of the valve stem 20 within the housing while the jaws 18 are in the closed position. This insertion provides air flow from the source through the housing 12 and the valve stem 20 into what is being inflated, typically a tire or the like. However, the device 10 may be used for inflation of anything in which a specific end pressure is desired. Connection of the housing 12 provides for air flow from the source, being at a higher pressure than the desired end inflation pressure, through the valve stem 20. The air pressure level within the housing will equal the back pressure through the valve stem 20 such that upon achieving the desired pressure corresponding to the pressure spring constant of the pressure spring 28, the pressure spring 28 will compress to move the rod 22 resulting in pivoting of the jaws 18 to facilitate release of the housing 12 from the valve stem 20.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A pressure specific air chuck device comprising:
a housing having a first end and a second end, said first end being open, said second end being open;
a pair of jaws positioned within said housing, said jaws being positioned adjacent to said second end of said housing, said jaws being configured for engaging a valve stem inserted into said second end;
a rod positioned within said housing, said rod being mechanically coupled to said pair of jaws such that linear movement of said rod within said housing pivots said pair of jaws between a closed position and an open position; and
a pressure spring positioned in said housing, said pressure spring biasing said rod to hold said pair of jaws in said closed position, said pressure spring having a pressure spring constant corresponding to a specific air pressure within said housing wherein said pressure spring compresses at said specific pressure within said housing whereby said rod pivots said pair of jaws into said open position.

2. The pressure specific air chuck device of claim 1, further comprising a channel extending into said housing from said first end, said rod having a primary end positioned within said channel, said channel having a diameter greater than a diameter of said rod wherein said channel is configured for air to pass through said channel around said rod.

3. The pressure specific air chuck device of claim 2, further comprising:
a ridge positioned within said housing, said ridge extending inwardly from an interior surface of said housing defining an aperture within said housing; and
said channel extending through said aperture.

4. The pressure specific air chuck device of claim 3, further comprising a channel seal positioned between said ridge and said channel.

5. The pressure specific air chuck device of claim 3, further comprising a piston positioned within said housing, said piston being positioned around said channel, said pressure spring being positioned between said piston and said ridge.

6. The pressure specific air chuck device of claim 5, further comprising a hole positioned in said channel, said hole being positioned between said piston and said first end of said housing wherein an air pressure within said housing is equalized on opposite sides of said ridge.

7. The pressure specific air chuck device of claim 1, further comprising a quick connect inlet coupled to said first end of said housing.

8. The pressure specific air chuck device comprising:
a cross member positioned within and extending across said housing, said cross member being positioned proximate said second end of said housing;
a pin being slidably positioned within said housing adjacent to said second end wherein said pin is configured for engaging the valve stem to allow air flow through the valve stem when the valve stem is inserted into said second end of said housing; and
a closure spring positioned between said cross member and said pin wherein said closure spring biases said pin towards said second end of said housing.

9. The pressure specific air chuck device of claim 1, further comprising:
each of said pair of jaws having a pivot end pivotally coupled to said housing, each of said pair of jaws having a flange extending from said pivot end inwardly within said housing;
a secondary end of said rod being pivotally coupled to said flange of each jaw of said pair of jaws wherein movement of said rod pivots said pair of jaws.

10. A pressure specific air chuck device comprising:
a housing having a first end and a second end, said first end being open, said second end being open;
a pair of jaws positioned within said housing, said jaws being positioned adjacent to said second end of said housing, said jaws being configured for engaging a valve stem inserted into said second end;
a rod positioned within said housing, said rod being mechanically coupled to said pair of jaws such that linear movement of said rod within said housing pivots said pair of jaws between a closed position and an open position;
a pressure spring positioned in said housing, said pressure spring biasing said rod to hold said pair of jaws in said closed position, said pressure spring having a pressure spring constant corresponding to a specific air pressure within said housing wherein said pressure spring compresses at said specific pressure within said housing whereby said rod pivots said pair of jaws into said open position;
each of said pair of jaws having a pivot end pivotally coupled to said housing, each of said pair of jaws having a flange extending from said pivot end inwardly within said housing;
a secondary end of said rod being pivotally coupled to said flange of each jaw of said pair of jaws wherein movement of said rod pivots said pair of jaws;
a channel extending into said housing from said first end, said rod having a primary end positioned within said channel, said channel having a diameter greater than a diameter of said rod wherein said channel is configured for air to pass through said channel around said rod;
a ridge positioned within said housing, said ridge extending inwardly from an interior surface of said housing defining an aperture within said housing, said channel extending through said aperture;
a channel seal positioned between said ridge and said channel;
a piston positioned within said housing, said piston being positioned around said channel, said pressure spring being positioned between said piston and said ridge;
a hole positioned in said channel, said hole being positioned between said piston and said first end of said housing wherein an air pressure within said housing is equalized on opposite sides of said ridge;
a quick connect inlet coupled to said first end of said housing;
a cross member positioned within and extending across said housing, said cross member being positioned proximate said second end of said housing;
a pin being slidably positioned within said housing adjacent to said second end wherein said pin is configured for engaging the valve stem to allow air flow through the valve stem when the valve stem is inserted into said second end of said housing; and
a closure spring positioned between said cross member and said pin wherein said closure spring biases said pin towards said second end of said housing.
